(19) United States
(12) Patent Application Publication
(10) Pub. No.: US 2018/0248684 A1
(43) Pub. Date: Aug. 30, 2018

(54) METHOD AND SYSTEM FOR DATABASE QUERIES

(71) Applicant: NOKIA SOLUTIONS AND NETWORKS OY, Espoo (FI)

(72) Inventors: Ian Justin OLIVER, Söderkulla (FI); Madeleine Linnea EKBLOM, Helsinki (FI); Yoan Jean Claude MICHE, Espoo (FI)

(21) Appl. No.: 15/753,720

(22) PCT Filed: Aug. 2, 2016
(86) PCT No.: PCT/EP2016/068387

§ 371 Date: Feb. 20, 2018

Related U.S. Application Data
(60) Provisional application No. 62/206,414, filed on Aug. 18, 2015.

(51) Int. Cl. H04L 9/00; G06F 17/30; H04L 9/08; H04L 29/06

(52) U.S. Cl. CPC H04L 9/008; G06F 17/30864; H04L 63/04; G06F 17/30377; H04L 9/0891; G06F 17/30312

(57) ABSTRACT

A method in a network includes: at a client having a memory and a processor, sending a first request to a proxy, the proxy including a memory and a processor; at the client, receiving a first response from the proxy; at the client, sending a second request to the proxy; from the proxy, sending an encrypted computed function to the client in response to the second request; and decrypting the computed function at the client.

### FIELD OF TECHNOLOGY

This disclosure relates generally to the field of database queries, and more particularly to a method and system for database queries utilizing homomorphic encryption (in its various forms, including garbled circuits), bloom filters (in various forms, including cryptographic, multi-dimensional, and combinations thereof), and private information retrieval.

### BACKGROUND

In recent years, privacy has become a greater engineering concern in the development of telecommunication networks and other information systems. In particular, secure two-party communication (“STC”), a scenario in which two parties communicate and compute a function such that the values (i.e., input values, output values, and intermediate values, including temporary values) are kept private, has become an important factor to consider in the design of intelligent systems such as telecommunication networks.

There are several existing databases that support STCs and PIR (private information retrieval), including, for example, CryptDB, TrustedDB®, and Cipherbase®. CryptDB® was developed by MIT® and includes an encrypted database stored in an untrusted server, a trusted proxy, and an application available through a client's computer. The goal of CryptDB® is to perform SQL queries (i.e., update, select, join, search) without revealing the data content to the untrusted server. In CryptDB®, the proxy acts as a translator between the client and the server.

TrustedDB® provides a privacy-preserving SQL database by using trusted hardware. In some cases, however, the use of trusted hardware can be expensive and performance-limiting. Cipherbase® is similar to TrustedDB®, but instead of using trusted hardware on its own, Cipherbase® uses a combination of trusted hardware and software techniques to simulate a fully homomorphic database supporting SQL queries. Sensitive information is stored on the server side within the network.

Existing STC methods have several drawbacks, such as varying results depending on the operation, framework, and input sizes. In addition, the time required to complete the computation, the amount of memory consumed, and the cost of the operation can be prohibitive. Further, in many cases adopting such existing methods requires changing and/or providing a new architecture for the existing system.

### SUMMARY

A method in a network includes: at a client having a memory and a processor, sending a first request to a proxy, the proxy including a memory and a processor; at the client, receiving a first response from the proxy; at the client, sending a second request to the proxy; from the proxy, sending an encrypted computed function to the client in response to the second request; and decrypting the computed function at the client.

A system includes: at least one network component, the network component including a memory and a processor; a client in communication with the network component, the client including a memory and a processor; a proxy in communication with the client; and a database in communication with the proxy. The system is configured to: at the client, send a first request to the proxy; at the client, receive a first response from the proxy; at the client, send a second request to the proxy; from the proxy, send an encrypted computed function to the client; and decrypt the computed function at the client.

A method includes: at a client having a memory and a processor, sending a first request to a proxy, the proxy including a memory and a processor; at the client, receiving a first response from the proxy; at the client, sending an encrypted client value to the proxy; at the proxy, retrieving a component value from a database in communication with the proxy, the component value being based on a component in the network. The method further includes, at the proxy, determining the computed function based on the encrypted client value and the retrieved component value; at the client, sending a second request to the proxy; from the proxy, sending an encrypted computed function to the client in response to the second request; and decrypting the computed function at the client.

### DESCRIPTION OF THE SEVERAL VIEWS OF THE DRAWINGS

To aid in the proper understanding of the present disclosure, reference should be made to the accompanying drawings, wherein:

FIG. 1 is an overview of a system architecture in accordance with an embodiment of the present disclosure;

FIG. 2 is a flow chart illustrating a method in accordance with an embodiment of the disclosure;

FIG. 3 is a flow chart illustrating a bloom filter population method in accordance with an embodiment of the present disclosure;

FIG. 4 is a flow chart illustrating a function computation method in accordance with an embodiment of the present disclosure;

FIG. 5 is a diagram illustrating a system in accordance with an embodiment of the present disclosure;

FIG. 6 is an overview illustrating communication between the client, the proxy, and the database, in accordance with the system illustrated in FIG. 5;

FIG. 7 is a flow chart illustrating a method in accordance with a further embodiment of the present disclosure;

FIG. 8 is a signal diagram illustrating communication between the client, the proxy, and the database in accordance with the method depicted in FIG. 7;

FIG. 9 is a flow diagram illustrating bloom filter population in the proxy, in accordance with the method depicted in FIG. 7;

FIG. 10 is a flow diagram illustrating bloom filter population in the database, in accordance with the method depicted in FIG. 7;

FIG. 11 is a flow diagram illustrating bloom filter queries between the client and the proxy, in accordance with the method depicted in FIG. 7;

FIG. 12 is a flow diagram illustrating communication between the client, proxy, and the database during a function evaluation in accordance with the method depicted in FIG. 7; and

FIG. 13 is an example distance calculation computed in accordance with the method depicted in FIG. 7.

### DETAILED DESCRIPTION

The present disclosure provides a method and system in a network that combines Bloom Filters, homomorphic encryption, and a trusted proxy in such a way that both a client query and a computation over a database can be protected from a privacy perspective. Both Cryptographic Bloom Filters (both single and multi-dimensional, hereinafter referred to as “CBF”) and Homormorphic Encryption (“HE”) are known to those having ordinary skill in the art. Briefly, a Bloom filter is a probabilistic data structure based on hash coding, and is primarily used for membership queries in a telecom network. The goal of a Bloom filter is to reduce the amount of memory required, and to provide a faster method for membership tests by using a combination of bitarray and hash functions. A typical Bloom filter includes a bitarray of length m, initially set to all “0”, and k hash functions. CBFs were developed as a way to allow a client to query a Bloom filter without revealing the content of the query to the Bloom filter. More specifically, CBFs can utilize a blind signature, which enables a client to obtain a signature from the server without revealing to the server what has been signed. In a CBF, normal hash functions with input x are replaced by new hash functions with input (x, signature(x)), such that the Bloom filter is encrypted and a signature is needed to query the Bloom filter. Homomorphic Encryption, or HE, allows computations to be performed over encrypted data, thereby preventing data leakage in cloud computing, for example. Because HE on its own does not enable private information retrieval, the present disclosure proposes a combination of CBFs and HE with a trusted proxy to insulate a client's requests and computation from a corresponding database.

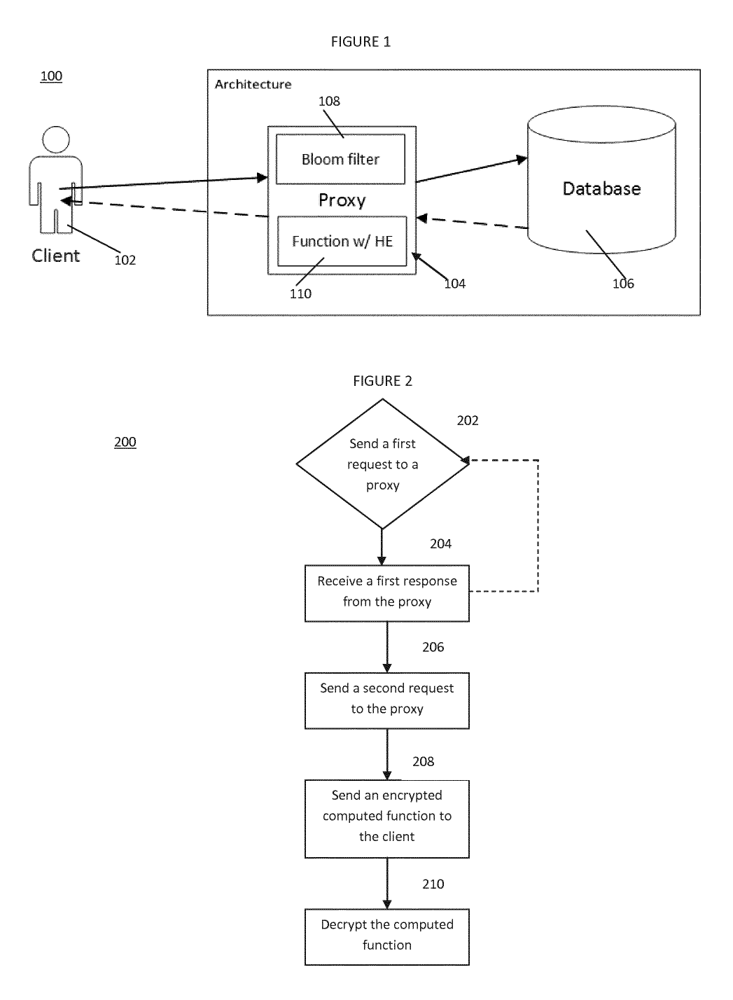

Referring now to FIG. 1, a system architecture 100 in accordance with the present disclosure includes a client 102 in communication with a trusted proxy 104 (also referred to herein as the proxy), wherein the trusted proxy is in communication with a database or server 106. As seen in FIG. 1, the trusted proxy 104 facilitates communication between the client 102 and the database 106, such that the client and the database do not directly communication with each other. This allows the identity of the client 102 to remain private and unknown to the database 106. The trusted proxy 104 is configured to perform two main functions: 1) to generate a CBF 108 and respond to CBF queries issued by the client 102; and 2) to retrieve a record from the database 106 based on the client's input and perform a function evaluation using the retrieved record and the client's data, using HE functionality 110. The database 106 has two main functions: indexing and function evaluation. In accordance with the present disclosure, the indexing of the database has been extracted and is performed within the trusted proxy 104, using the CBF 108. Similarly, the function evaluation generally executed by the database 106 has been extracted and is performed within the trusted proxy 104 by applying HE (using the HE functionality 110).

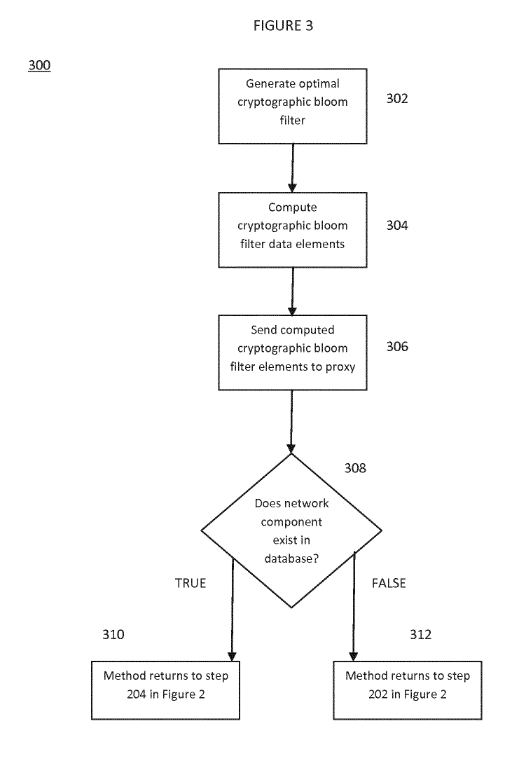

In the architecture shown in FIG. 1, the client 102 sends private data and wishes to receive public data in return. Accordingly, and as will be described in further detail below, the client 102 communicates/queries the proxy 104, which receives any private data necessary from the client. In turn, and using a combination of HE 110 and CBF 108, the proxy 104 communicates with the database 106, which may include encrypted data, but for the purposes of this disclosure, is not encrypted in and of itself. The database 106 returns the encrypted data to the proxy 104, which then sends the encrypted data back to the client 102. The client 102 can then, if necessary, decrypt the received data. The goal of this architecture is to ensure that the database 106 is unaware of the private information communicated between the client 102 and the proxy 104. The methods and system utilized to realize this goal will be described in further detail below with reference to FIGS. 2-13.

Turning now to FIG. 2, a method 200 in a telecommunications network is provided and includes, at the client 102, sending a first request to the proxy 104 (202). The first request can include, for example, a request to index the database 106 in communication with the proxy 104, which will be described in further detail below. At 204, the client 102 receives a first response from the proxy 104. Next, at 206, the client 102 sends a second request to the proxy 104, and in response to the second request, the proxy sends an encrypted computed function to the client (208). At 210, the client 102 decrypts the computed function.

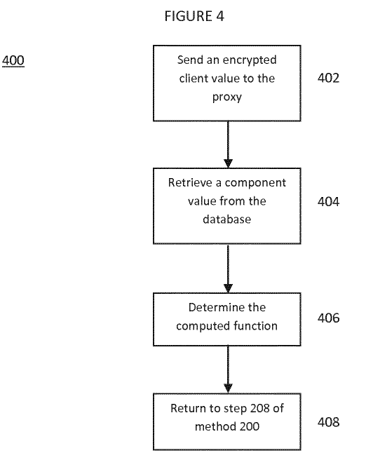

As stated above with respect to step 202, the client 102 sends the first request to the proxy 104, which in accordance with the present disclosure, includes a request to index the database 106. The indexing of the database can be performed at the cryptographic bloom filter 108 in the proxy 104. In accordance with the first request, the client 102 queries the proxy 104 to determine the existence of a network component/element, such as a base station, for example (shown in FIG. 4). This initial query determines whether the network component is part of the database 106, and in the case where a negative response is provided by the proxy, avoids the need for further unnecessary calculations. In other words, if the initial query returns a “false” or “negative” response (i.e., that the network component is not part of the database 106), the method 200 can end or return to step 202 (see dashed line in FIG. 2) until a positive or “true” response is received (i.e., that the network component is part of the database).

FIG. 3 illustrates a method 300 used to determine whether the network component is part of the database 106. At 302, the database 106 generates an optimal cryptographic bloom filter based on a dataset in the database. At 304, the database 106 computes cryptographic bloom filter data elements based on dataset changes in the database, and sends the computed cryptographic bloom filter data elements to the proxy 104 at 306. Because the proxy 104 now has the necessary data elements stored in the CBF 108, the client 102 can then, at 308, query the proxy regarding the existence of the network component within the database 106. If the proxy 104 returns a “true” response, then at 310 the method 300 returns to step 204, and continues in accordance with the method 200 described with respect to FIG. 2. However, if the proxy 104 returns a “false” response, then at 312, the method 300 returns to step 202 and proceeds as indicated. Alternatively, at 312, the method 300 could return to step 302 and repeat until a “true” response is received from the proxy 104. Prior to the query at 308, a blind signature scheme (not shown) can be implemented, enabling the client 102 to blind the queried element before sending the query to the proxy 104. Such a blind signature scheme would require two rounds of communication between the client and the proxy, at which point the proxy 104 can proceed to provide the proxy with either the “true” or “false” response. The blind signature is a method of protecting and authenticating the communication. It is not a requirement of the present method, nor is it the only approach. For example, other authentication schemes can be used, but blind signatures solve a number of cryptographic key communication problems. Accordingly, the Blind Signatures can be replaced with any other transport and authentication protection schemes as necessary and/or required

While FIG. 3 and the above disclose that the database 106 generates and computes the CBF 108, it is also possible for the proxy 104 to generate and populate the CBF 108. Specifically, the proxy 104 can generate an optimal cryptographic bloom filter 108 based on a dataset in the database 106, and can then update the data elements in the cryptographic bloom filter based on dataset changes in the database. The updating of the cryptographic bloom filter can include one of deleting data elements in the bloom filter and inserting data elements into the bloom filter. If the data is deleted from the CBF, hash values in the CBF can be updated and the counter can be reduced; alternatively, the entire CBF can be regenerated. As such updating of CBFs is generally known to those having skill in the art, it will not be described any further herein.

As stated above and in FIG. 2, at 206, the second request is sent to the proxy 104. In accordance with the present disclosure, the second request can include requesting a computing of a function by the proxy. As will be described in further detail below and with reference to method 400 illustrated in FIG. 4, the computing of the function can be performed by the proxy 104 using homomorphic encryption or HE. Specifically, upon receipt of the second request and at 402, the client 102 can send an encrypted client value to the proxy 104. At 404, the proxy retrieves a component value from the database 106 in communication with the proxy, the component value being based on a component in the network. At 406, the proxy determines the computed function based on the encrypted client value and the retrieved component value. For example, the client value, the component value retrieved from the database, and the corresponding computed function can be one of a distance, a time, a location, and a string of textual data.

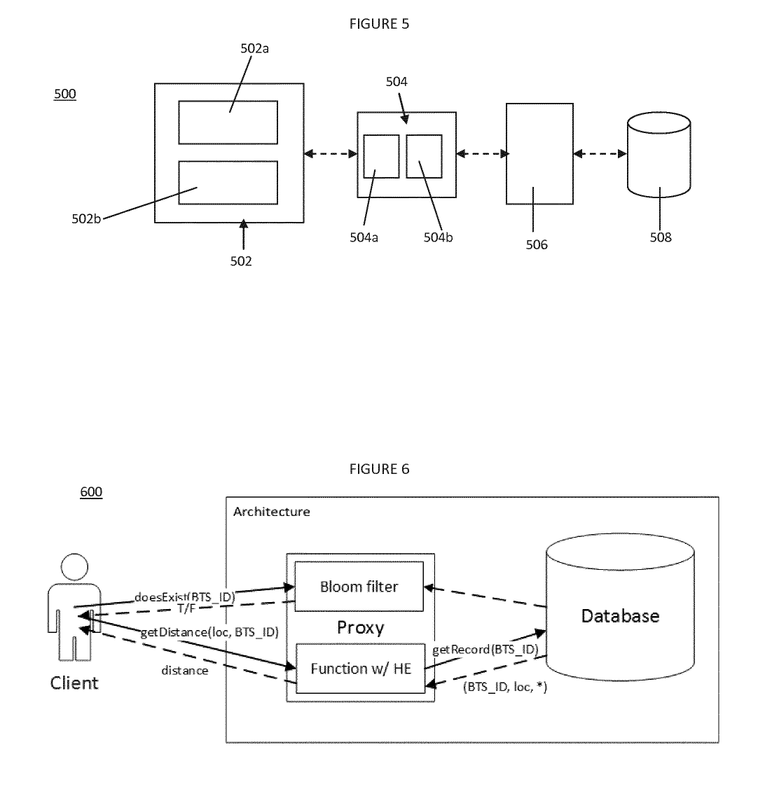

Referring now to FIGS. 5-13, a specific use case for the present disclosure will be described. A system 500 is provided and includes a network component 502, the network component including a memory 502a and a processor 502b. The system 500 further includes a client 504 in communication with the network component, the client including a memory 504a and a processor 504b. A proxy 506 is provided and is in communication with the client 504, and a database 508 is in communication with the proxy. As shown in FIG. 5 and in the architecture 600 shown in FIG. 6, the client 504 communicates solely with the proxy 506. In other words, the client 504 does not communicate directly with the database 508. As will be described in further detail below, the system 500 is configured to: at the client 504, send a first request to the proxy 506; at the client, receive a first response from the proxy; at the client, send a second request to the proxy; from the proxy, send an encrypted computed function to the client; and decrypt the computed function at the client.

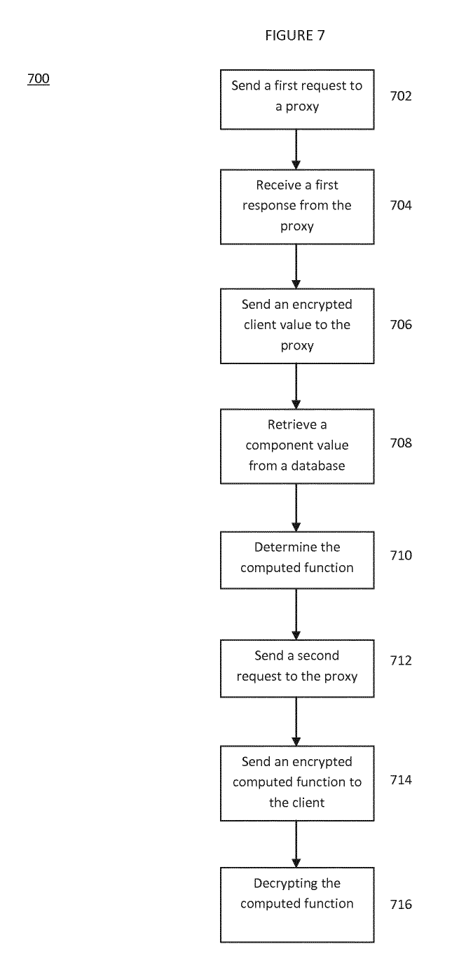

In the present system 500, the network component 502 is a base station, and the client 504 is a user device having a GPS connection. In the current scenario, the client or user device 504 would like to know their location relative to the base station 502, but without revealing their location to the database 508. Referring now to FIG. 7-13, a method 700 for determining the location of the client 504 relative to the base station 502 is provided.

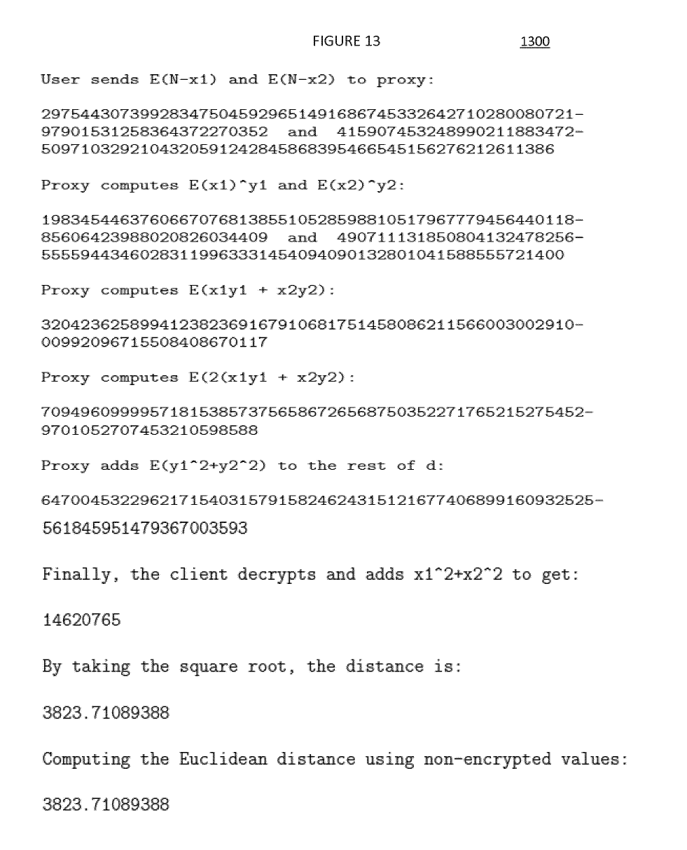

At 702, the client or user device 504 sends a first request to the proxy 506, and at 704, receives a first response from the proxy. At 706, the client 504 sends an encrypted client value to the proxy. The encrypted client value can be, for example, the location of the user device 504. This client value is encrypted and only seen by the trusted proxy 506. The proxy 506 then retrieves a component value from the database 508 in communication with the proxy (708). In this scenario, the component value is based on the component 502 in the network, and more specifically, is a location of a base station within the network, or alternatively, is a proximity location of the base station relative to the client 504. At 710, the proxy 506 determines the encrypted computed function based on the encrypted client value and the retrieved component value, the details of which are further described below with respect to FIG. 13. At 712, the user device 504 sends a second request to the proxy 506, requesting the encrypted computed function, and in response, the proxy sends the encrypted computed function to the client (714). Normally a client sends parameters to a function in the proxy, but in the present method 700, it is possible to send a function as a parameter, which is known as a higher-order function. At 716, the client 502 decrypts the computed function.

In accordance with this use case, the computed function is the distance between the user device 504 and the network component or base station 502. In accordance with the method 700, neither the proxy 506 nor the database 508 is aware of the user device's location, thereby ensuring the privacy of the user device's location. The device 504 is the only component in the system 600 that is aware of the distance between itself and the network component or base station 502. Accordingly, the present systems/methods ensure a secure two-way communication between the client and the proxy, without divulging confidential information related to the client.

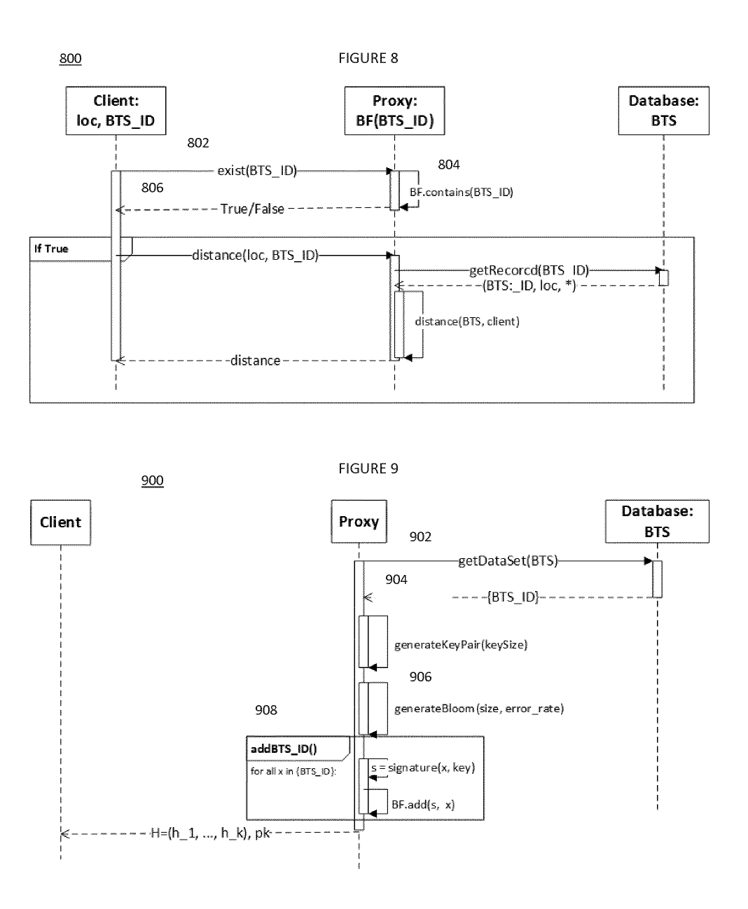

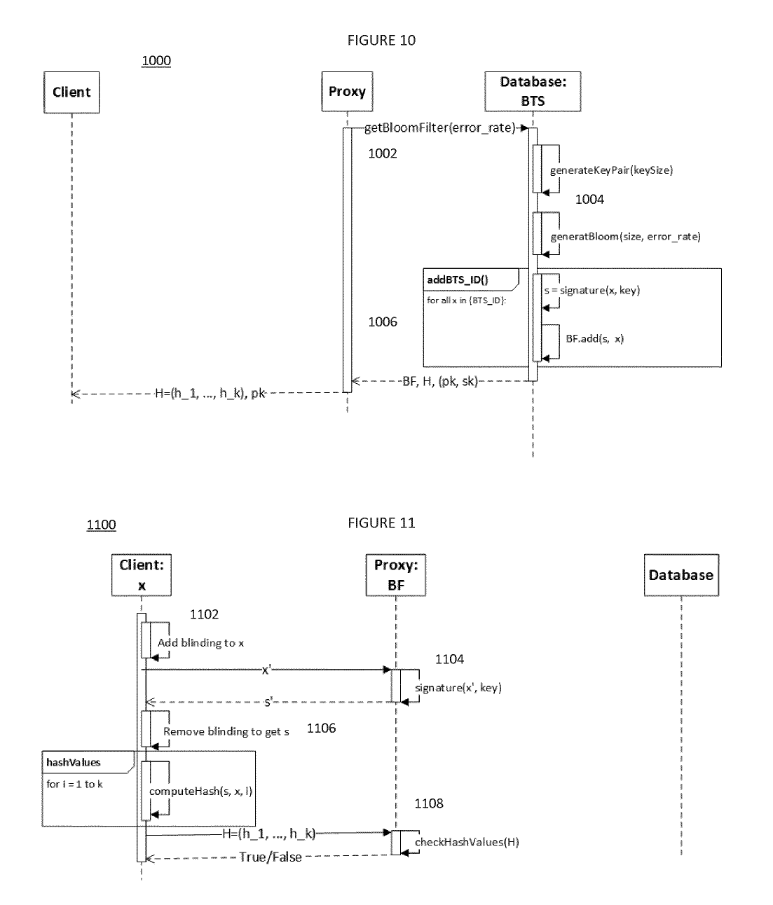

FIGS. 8-12 include signaling diagrams illustrating the communication between the client 504, proxy 506, and database 508 in accordance with the method 700. Specifically, FIG. 8 illustrates a signal flow 800 between the client 504 and the proxy 506, in which the client requests whether the network component (in this case, the base station) exists as part of the network. At 802, the user device 504 queries the proxy 506 regarding the existence of the base station 502 within the network. The proxy 504 consults the CBF 108 at 804 (which is generated in accordance with FIGS. 9 and 10 below) to determine if the appropriate base station ID exists. The proxy 506 then returns either a “true” or a “false” response to the client 504 (806).

FIGS. 9 and 10 illustrate signal flows 900 and 1000, respectively, between the proxy 506 and the database 508. In signal flows 900 and 1000, the CBFs are populated either by the proxy 506 (see FIG. 9) or the database 508 (see FIG. 10). These signal flows correspond with the method 300 described above and illustrated in FIG. 3. In signal flow 900, at 902 the proxy 506 requests a dataset from the database 508, which then sends the dataset to the proxy 506 at 904. At 906, the proxy 506 generates an optimal cryptographic bloom filter 108 based on the dataset in the database 508, and can then update the data elements in the cryptographic bloom filter (908) based on dataset changes in the database. The updating of the cryptographic bloom filter can include one of deleting data elements in the bloom filter and inserting data elements in the bloom filter. If the data is deleted from the CBF, hash values can be updated and the counter can be reduced; alternatively, the entire CBF can be regenerated. As such updating of CBFs is generally known to this having skill in the art, it will not be described any further herein.

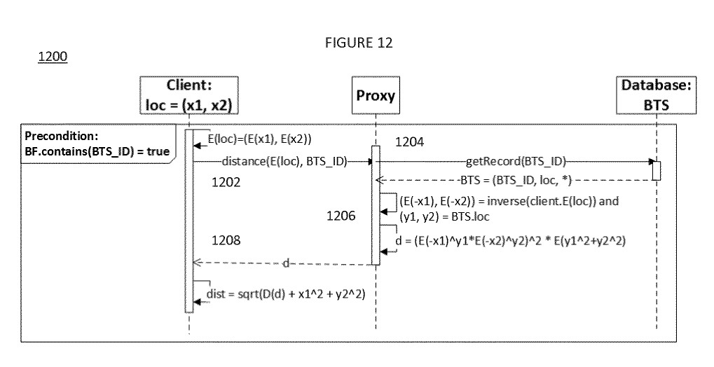

Signal flow 1000 illustrates an alternative method for populating the CBF, wherein the CBF is generated at the database 508. At 1002, the database 508 generates an optimal cryptographic bloom filter based on a dataset in the database. At 1004, the database 508 computes cryptographic bloom filter data elements based on dataset changes in the database, and sends the computed cryptographic bloom filter data elements to the proxy 506 (step 1006). Because the proxy 506 now has the necessary data elements stored in the CBF 108, the client 504 can then query the proxy 506 regarding the existence of the base station 502 within the database, as shown in signal diagram 1100 in FIG. 11. At 1102, the blind signature scheme is configured so that the user device 504 can blind the queried element (i.e., the base station in this scenario) before sending the query to the proxy 506. Once the query is sent at 1104, the blind signature can be removed at 1106. As indicated above, because blind signature schemes are known in the art, the configuration of such a scheme will not be further described herein. At 1108, the proxy 506 returns either a “true” or a “false” response to the user device 504, indicating either that the base station 502 exists as part of the database 508 or that the base station does not exist as part of the database, respectively. If the proxy returns a “true” response to the user device 504, the method 700 continues on to steps 706-714 which are also depicted in signal diagram 1200 of FIG. 12, described below.

At 1202 in signal diagram 1200, the user device 504 sends the encrypted client value to the proxy 506, which in this scenario is the location of the device. At 1204, the proxy 506 retrieves the location of the base station 502 from the database 508. At 1206, the proxy 506 determines the computed function (as requested by the device in the second request) based on the encrypted device location and the retrieved base station location using homomorphic encryption, the details of which are further described below with respect to FIG. 13. At 1208, the proxy 506 sends the encrypted computed function to the client 504.

FIG. 13 illustrates an example distance calculation 1300 utilizing the above-described method 700. In this calculation 1300, the user device 504 has location x, where x=(123,543). The base station 502 has location y, where y=(3456,2219). To compute the distance between x and y using the secure two-party communication methods described above, the computation is split between the device/client 504 and the proxy 506 such that the proxy does not learn the client's position and the client learns only the distance, d. The user device 504 encrypts their location before sending it to the proxy 506, and the proxy retrieves the unencrypted location of the base station. Using a Paillier computation method (which is one well known method using for encryption calculations) with a 128-bit key, the encrypted distance d is calculated using the following function:

$${dist}_{enc} ( x , y ) = \sqrt{D ( {( {ɛ ( - x 1 )}^{y 1} {ɛ ( - x 2 )}^{y 2} )}^{2} E ( y {1}^{2} + y {2}^{2} ) ) + x {1}^{2} + x {2}^{2}}$$

A 128-bit key was utilized in the present example for speed purposes, but it is recognized that shorter keys can be used. The above-identified distance function is one example of computing distance in a homomorphically encrypted manner, and it is appreciated that other functions may be utilized. Further, although a Pailler scheme was utilized above, it is appreciated that alternative encryption schemes can be utilized, such as El Gamal or other homomorphic encryption schemes as known by those having skill in the art. The calculation 1300 results in a Euclidian distance between the base station 502 and the user device 504 of 3823.71089388. By utilizing the above-identified methods to compute the distance between the base station 502 and the device 504, the proxy does not learn anything about the device's position, and the only component that receives the computed distance is the device. The database 508 does not learn the origin of the device query when the proxy 506 retrieves the base station location. Accordingly, the device/client maintains its privacy during the entire distance calculation.

The present disclosure provides a method and system for providing secure two-way communication by using a combination of cryptographic bloom filters and homomorphic encryption to insulate a client's requests and a resulting computed function from a database in a network. The present disclosure maintains the client's privacy such that neither a proxy nor a database is aware of its location. The inclusion of a trusted proxy in the present system and method also provide client protection from the database, as it hides the origin of the client's query and its contents. Specifically our method provides a mechanism to “wrap” an existing un-trusted database by extracting certain indices (as bloom filters) and certain functions (implemented using homomorphic encryption techniques) into a trusted proxy. As indicated above, ‘trust’ means that the proxy does not reveal any or as little as possible information to the database, as well as hiding the identity of the client. The trusted proxy learns as little as possible about the client's computations, eg: by HE and Cryptographic BFs described in detail above. The present system and methods can also be applied to existing databases, since the homomorphic encryption and cryptographic bloom filters in the trusted proxy “wrap” the existing database, preventing it from obtaining knowledge about the client's location/queries. Further, assuming that a predefined/optimized API has already been provided, the present methods can be applied to existing systems.

Embodiments of the present disclosure may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present disclosure can include a computer program product comprising a computer-readable storage medium bearing computer program code embodied therein for use with a computer, the computer program code comprising code for performing any of the methods and variations thereof as previously described. Further, the present disclosure can also include an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the disclosure are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the disclosure, these descriptions should not be viewed in a limiting sense. Rather, there are several variations and modifications which may be made without departing from the scope of the present disclosure as defined in the appended claims.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the invention. In order to determine the metes and bounds of the disclosure, therefore, reference should be made to the appended claims.

The following abbreviations that may be found in the specification and/or the drawing figures are defined as follows:
CBF Cryptographic Bloom Filter
HE Homomorphic Encryption
STC Secure Two-Party Communication

1. A method in a network comprising:
at a client having a memory and a processor, sending a first request to a proxy, the proxy including a memory and a processor;
at the client, receiving a first response from the proxy;
at the client, sending a second request to the proxy;
from the proxy, sending an encrypted computed function to the client in response to the second request; and
decrypting the computed function at the client.

2. The method of claim 1 wherein the first request includes requesting an indexing of a database in communication with the proxy.

3. The method of claim 2 wherein the indexing of a database is performed at a cryptographic bloom filter in the proxy.

4. The method of claim 3 wherein the first request further includes:
at the proxy, generating an optimal cryptographic bloom filter based on a dataset in the database; and
at the proxy, updating data elements in the cryptographic bloom filter based on dataset changes in the database, wherein updating the cryptographic bloom filter includes one of deleting data elements in the bloom filter and inserting data elements in the bloom filter.

5. The method of claim 3 wherein the first request further includes:
at the database, generating an optimal cryptographic bloom filter based on a dataset in the database;
at the database, computing cryptographic bloom filter data elements based on dataset changes in the database; and
sending the computed cryptographic bloom filter data elements to the proxy.

6. The method of claim 1 wherein the second request includes requesting a computing of a function by the proxy.

7. The method of claim 6 wherein the computing of a function is performed by the proxy using homomorphic encryption.

8. The method of claim 1 further including, prior to the sending an encrypted computed function to the client:
at the client, sending an encrypted client value to the proxy;
at the proxy, retrieving a component value from a database in communication with the proxy, the component value being based on a component in the network; and
at the proxy, determining the computed function based on the encrypted client value and the retrieved component value.

9. The method of claim 8 wherein the component value retrieved from the database is one of a distance, a time, a location, and a string of textual data.

10. A system comprising:
a network component, the network component including a memory and a processor;
a client in communication with the network component, the client including a memory and a processor;
a proxy in communication with the client; and
a database in communication with the proxy;
wherein the system is configured to:
at the client, send a first request to the proxy;
at the client, receive a first response from the proxy;
at the client, send a second request to the proxy;
from the proxy, send an encrypted computed function to the client; and
decrypt the computed function at the client.

11. The system of claim 10 wherein the network component is a base station.

12. The system of claim 10 wherein the client communicates solely with the proxy.

13. The system of claim 10 wherein the proxy communicates with both the proxy and the database.

14. A method comprising:
at a client having a memory and a processor, sending a first request to a proxy, the proxy including a memory and a processor;
at the client, receiving a first response from the proxy;
at the client, sending an encrypted client value to the proxy;
at the proxy, retrieving a component value from a database in communication with the proxy, the component value being based on a component in the network;
at the proxy, determining the computed function based on the encrypted client value and the retrieved component value;
at the client, sending a second request to the proxy;
from the proxy, sending an encrypted computed function to the client in response to the second request; and
decrypting the computed function at the client.

15. The method of claim 14 wherein the sending an encrypted client value to the proxy includes sending a client location value to the proxy.

16. The method of claim 15 wherein the retrieving a component value from a database includes retrieving a proximity value based on the network component, wherein the proximity value includes a proximity of the network component relative to the client.

17. The method of claim 16 wherein the network component is a base station.

18. The method of claim 16 wherein determining the computed function includes determining a distance between the client and the network component.

19. The method of claim 14 wherein the first request includes requesting an indexing of a database in communication with the proxy, wherein the indexing of a database is performed at a cryptographic bloom filter in the proxy.

20. The method of claim 14 wherein the second request includes requesting a computing of a function by the proxy, wherein the computing of a function is performed by the proxy using homomorphic encryption.
